(19) United States
(12) Patent Application Publication
(10) Pub. No.: US 2026/0310537 A1
(43) Pub. Date: Oct. 8, 2026

(54) ADDRESSING PROBABLE ROOT CAUSES BASED ON LOGS RELEVANT TO SYSTEM OPERATION

(71) Applicant: Dell Products L.P., Round Rock, TX (US)

(72) Inventors: RAMESH DODDAIAH, Westborough, MA (US); SUMANTA KASHYAPI, Redmond, WA (US); CORINNE SCHULZE, Hopkinton, MA (US); MING QIAN, Newton, MA (US)

(21) Appl. No.: 19/169,349

(22) Filed: Apr. 3, 2025

(51) Int. Cl. G06F 11/07

(52) U.S. Cl. CPC G06F 11/079; G06F 11/0778; G06F 11/0793

(57) ABSTRACT

Methods and systems for managing operation of client devices are disclosed. To manage operation of the client devices, a ranked list of probable root causes may be identified in response to an occurrence of an issue impacting a client device. The ranked list of probable root causes may be obtained using a ranked list of counters (e.g., relevant to a frequency that a corresponding portion of a codebase of the client device executes while the issue impacts desired operation), a relevant portion of sub-portions of logs deemed to be anomalous, and potential root causes associated with the relevant portion of logs (e.g., based on a knowledge base). The sub-portions of logs and corresponding potential root causes may be identified prior to and stored for subsequent retrieval in response to the occurrence of the issue. The ranked list of probable root causes may be addressed to attempt to remediate the issue.

### FIELD

Embodiments disclosed herein relate generally to managing operation of client devices. More particularly, embodiments disclosed herein relate to managing the operation of the client devices by using anomalous logs and counters to identify probable root causes and performing a remediation process to address the probable root causes.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2C show data flow diagrams in accordance with an embodiment.

FIGS. 3A-3B show flow diagrams illustrating methods in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of client devices (e.g., data processing systems). The client devices may provide computer-implemented services to any type and number of other devices and/or users of the client devices. The computer-implemented services may include any quantity and type of such services.

While providing the computer-implemented services, an issue may occur that may impact operation (e.g., reduce performance, reduce functionality, etc.) of a client device. To resolve the issue, probable root causes of the issue may be identified and addressed via performance of a remediation process to place the client device in a desired operating state. To identify the probable root causes, an entity tasked with managing operation of the client device may analyze logs generated by at least a portion of the client devices.

However, a quality of the computer-implemented services may be impacted by an ability of the entity to identify the root causes in a timely and/or precise manner. For example, the entity (e.g., a support engineer) may misdiagnose the issue and/or performance of a remediation process may be delayed due to limited information possessed by the entity with respect to the issue, inability to analyze the logs in a timely manner (e.g., due to a volume of the logs), and/or any other limitations.

To manage the operation of the client device in response to the occurrence of the issue, a remediation process may be performed using an agentic agent and a prioritized portion of the logs. To do so, a relevant portion of sub-portions of the logs may be obtained based on the occurrence of the issue. The relevant portion of sub-portions of the logs may be deemed to be anomalous (e.g., relative to other portions of the logs) and be associated with corresponding potential root causes. The sub-portions of the logs may be identified via anomaly detection (e.g., at an individual device level, a system level, etc.) and may associated with predefined potential root causes (e.g., via classification).

Additionally, a ranked list of counters for the data processing system may be obtained based on a level of anomalousness for each counter. The counter may indicate a frequency that a corresponding portion of a codebase of client device executes while the issue impacts desired operation of the client device. The ranking of the counters may be based, for example, on a level of anomalous of a counter relative to a historical frequency distribution for the counters. As such, a certain counter that deviates from a normal frequency may be indicative of a failure relevant to the occurrence of the issue.

Furthermore, the relevant portion of the sub-portions of the logs may be prioritized by rank ordering log lines of the relevant portion based on the ranked list of the counters. By doing so, a result may be obtained that may indicate more precise log lines, potential root causes associated with the log lines, and/or any other information usable to diagnose the issue. The result may be used to generate at least one prompt for use by an agentic agent (e.g., an agentic artificial intelligence model) in obtaining a ranked list of probable root causes for the issue and subsequent attempts to remediate the issue by addressing the probable root causes.

In an embodiment, a method for managing operation of client devices is provided. The method may include: (i) identifying an occurrence of an issue impacting desired operation of a client device of the client devices; (ii) in response to the occurrence of the issue: (a) obtaining a ranked list of counters for the client device based on a level of anomalousness for each counter of the counters, a counter of the counters indicating a frequency that a corresponding portion of a codebase of the client device executes while the issue impacts the desired operation; (b) obtaining, based on the occurrence, a relevant portion of sub-portions of logs that are deemed to be anomalous and corresponding potential root causes for the sub-portions of the logs; (c) prioritizing sub-portions of the relevant portion of the sub-portions of the logs based on the ranked list of counters; and (d) initiating performance of a remediation process that is based on the prioritized sub-portions of the relevant portion of the sub-portions of the logs to attempt to place the client device in a desired operating state to facilitate continued provisioning of desired computer implemented services.

The method may also include: (i) obtaining logs from the client devices; (ii) identifying, by performing anomaly detection, the sub-portions of the logs; and (iii) identifying corresponding potential root causes for each of the sub-portions of the logs using a knowledge base.

The anomaly detection may be a multi-level anomaly detection process, the multi-level anomaly detection classifying the sub-portions of the logs at an individual device level and at a system level to identify the sub-portions of the logs.

Obtaining the relevant portion of the sub-portions of the logs may include: (i) filtering the sub-portions of the logs and corresponding potential root causes based on the issue to obtain the relevant portion.

The ranked list of counters may be ranked based on the level of anomalousness of each of the counters relative to a historical frequency distribution for the counters.

Prioritizing wherein prioritizing the portion of the sub-portions of the relevant portion may include: (i) rank ordering the sub-portions of the relevant portion of the sub-portions of the logs based on the ranked list of the counters.

Initiating the performance may include: (i) generating, based on the rank ordering and the issue, at least one prompt; (ii) initiating the performance of the remediation process by an agentic agent using the at least one prompt.

The agentic agent may be adapted to attempt to obtain a ranked list of probable root causes of the issue based on the at least one prompt.

The agentic agent may further be adapted to attempt to remediate the issue by iteratively addressing each of the probable root causes until the issue is resolved or the ranked list is exhausted.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

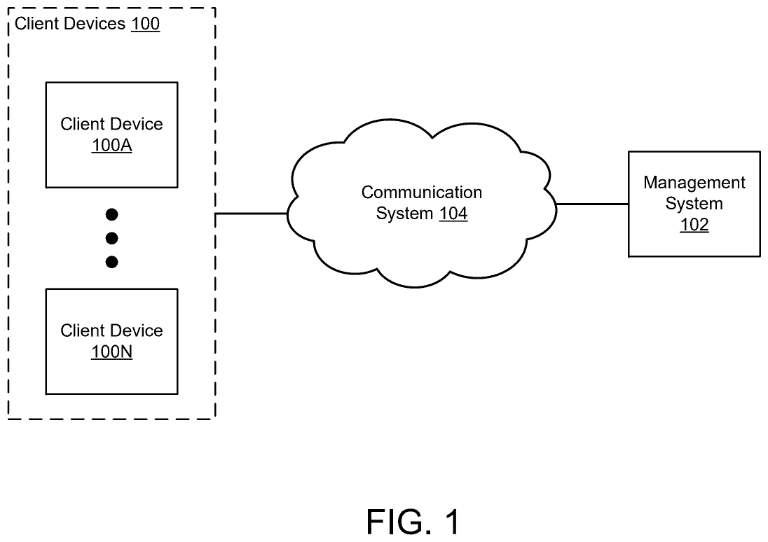

Turning to FIG. 1, a block diagram illustrating a system in accordance with an embodiment is shown. The system shown in FIG. 1 may provide for management of client devices (e.g., data processing systems) that may provide, at least in part, computer-implemented services (e.g., to user of the system and/or devices operably connected to the system).

The system may include any number of client devices 100 (e.g., computing devices) that provide the computer-implemented services. For example, client devices 100 may include one or more client devices (e.g., 100A, 100B, etc.) that may independently and/or cooperatively provide the computer-implemented services.

The computer-implemented services may include any type and quantity of computer-implemented services. The computer-implemented services may include, for example, database services, data processing services, electronic communication services, and/or any other services that may be provided using one or more computing devices. The computer-implemented services may be provided by, for example, client devices 100, management system 102, and/or any other type of devices (not shown in FIG. 1). Other types of computer-implemented services may be provided by the system shown in FIG. 1 without departing from embodiments disclosed herein.

To provide the computer-implemented services, client devices 100 may host applications that provide these (and/or other) computer-implemented services. The applications may be hosted by one ore more of client devices 100. Any of client devices 100, and components thereof, as well as hosted entities (e.g., applications that provide the computer-implemented services, other applications that manage the operation of client devices 100, hardware components, etc.), may be subject to undesired operation. For example, the hardware and/or software components may operate in a manner that diverges from nominal (e.g., desired) operation due to various operating conditions, design flaws, and/or any other reasons.

While operating, any of these components of a client device (e.g., 100A) may generate one or more logs. A log may include be a data structure that may include operational information regarding client device 100A, such as, for example, descriptions of conditions encountered by a components, a time when the condition was encountered, an identifier associated with a condition and/or generator of the log, an indication of a relative level of importance of the encountered conditions, and/or any other type of information. The logs may be used by an entity tasked with managing operation of client devices 100. For example, the entity may identify a root cause of an issue impacting the desired operation of at least one client device and attempt to address the root cause.

However, a quality of the computer-implemented services provided by client devices 100 may be impacted by an ability of the entity to identify the root causes in a timely and/or precise manner. For example, the entity (e.g., a support engineer) may misdiagnose the issue and/or a remediation process may be delayed due to limited information being available to the entity with respect to the issue, an inability to analyze the logs in a timely manner (e.g., due to a volume of the logs), and/or any other limitations. Consequently, an incorrect conclusion may be obtained with regard to an appropriate remediation process to perform to address the issue, a time to resolve the issue may be delayed, and/or any other conditions may occur that may negatively impact an ability of the client device to continue provisioning desired computer-implemented services.

In general, embodiments disclosed herein relate to systems, devices, and methods for managing operation of client devices. To manage the operation of the client devices, a remediation process may be performed based on a ranked list of probable root causes of the issue. The ranked list of probable root cases may be obtained, for example, by a management system (e.g., 102) and based, at least in part, on information available to the management system with respect to operation of the client devices (e.g., logs, counters, etc.).

To do so, a relevant portion of sub-portions of the logs may be obtained based on the occurrence of the issue. The sub-portions of the logs may be deemed to be anomalous (e.g., relative to other portions of the logs) and be associated with corresponding potential root causes. The sub-portions of the logs may be identified via anomaly detection (e.g., at an individual device level, a system level, etc.) and may associated with predefined potential root causes (e.g., via classification). For example, client devices 100 may generate a significant volume of logs that may reduce a likelihood that logs relevant to a certain issue may be obtained and used to diagnose the issue in a timely manner. Because at least a portion of the logs may not be relevant to the certain issue (e.g., logs generated during nominal operation of the client device), the sub-portions of the logs may be identified and/or stored for subsequent retrieval (e.g., from a storage for the identified sub-portions of the logs) in response to the occurrence of the issue.

Additionally, a ranked list of counters for the data processing system may be obtained based on a level of anomalousness for each counter. The counter may indicate a frequency that a corresponding portion of a codebase of client device executes while the issue impacts desired operation of the client device. The ranking of the counters may be based, for example, on a level of anomalous of a counter relative to a historical frequency distribution for the counters. For example, a certain counter that deviates from a normal frequency may be indicative of a failure relevant to the occurrence of the issue.

Furthermore, the relevant portion of the sub-portions of the logs may be prioritized by rank ordering log lines of the relevant portion based on the ranked list of the counters. By doing so, a result may be obtained that may indicate more precise log lines, potential root causes associated with the log lines, and/or any other information usable to diagnose the issue. The result may be used to generate at least one prompt for use by an agentic agent (e.g., an agentic artificial intelligence model) in obtaining a ranked list of probable root causes for the issue and subsequent attempts to remediate the issue by addressing the probable root causes.

To provide the above noted functionality, the system may include client devices 100, and management system 102. Each of these components is discussed below.

Client devices 100 may include any number of client devices (e.g., 100A-100N) that may individually and/or cooperatively provide at least a portion of the computer-implemented services. While providing the at least a portion of the computer-implemented services, each client device (e.g., 100A, 100B, etc.) of client devices 100 may communicate with and/or obtain information from management system 102. For example, client device 100A generate information (e.g., logs, telemetry data, etc.) relevant to the operation of client device 100A, identify that an issue has occurred impacting desired operation of client device 100A, provide a support request to management system 102 indicating a request to address the issue, obtain management requests to modify operation of client device 100A from management system 102 (e.g., as part of a remediation process), and/or communicate any other information. Client device 100A may subsequently perform actions based on the information obtained from management system 102 to update operation of client device 100A.

Management system 102 may, as discussed above, provide remote management services. Management system 102 may include, for example, a data processing system operated an owner of client devices 100. To provide the remote management services, management system 102 may interact with client devices 100 to obtain and/or provide information (e.g., data) relevant to operation of client devices 100. For example, management system 102 may (i) collect logs from at least a portion of client devices 100, (ii) identify an occurrence an issue impacting at least one client device (e.g., via monitoring operation of the client devices 100, receiving a request from the at least one client device, etc.), (iii) obtain a ranked list of counters for the at least one client device (e.g., 100A), (iv) obtain a relevant portion of sub-portions of logs deemed to be anomalous and corresponding potential root causes based on the issue, (v) initialize performance of a remediation process to attempt to place client device 100A in a desired operating state, and/or perform any other actions.

To provide its functionality, management system 102 may, for example, generate at least one prompt for use by an agentic agent (e.g., an agentic artificial intelligence model). The agentic agent may be adapted to obtain a ranked list of probable root causes using any of the information relevant to operation of client devices 100 (e.g., logs, counters, etc.) and/or attempt to remediate the issue by iteratively addressing each of the probable root causes until the issue is resolved or the ranked list is exhausted.

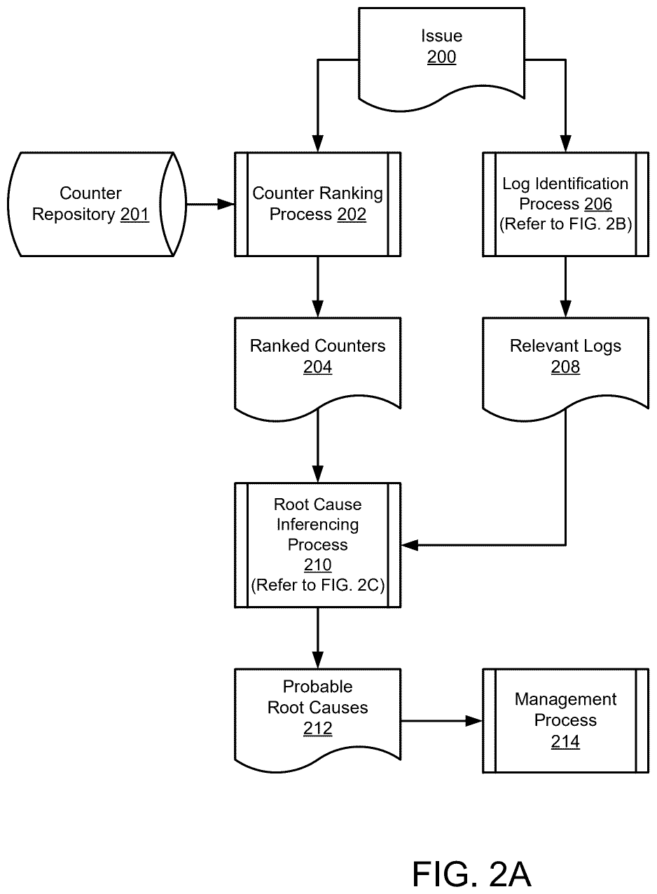

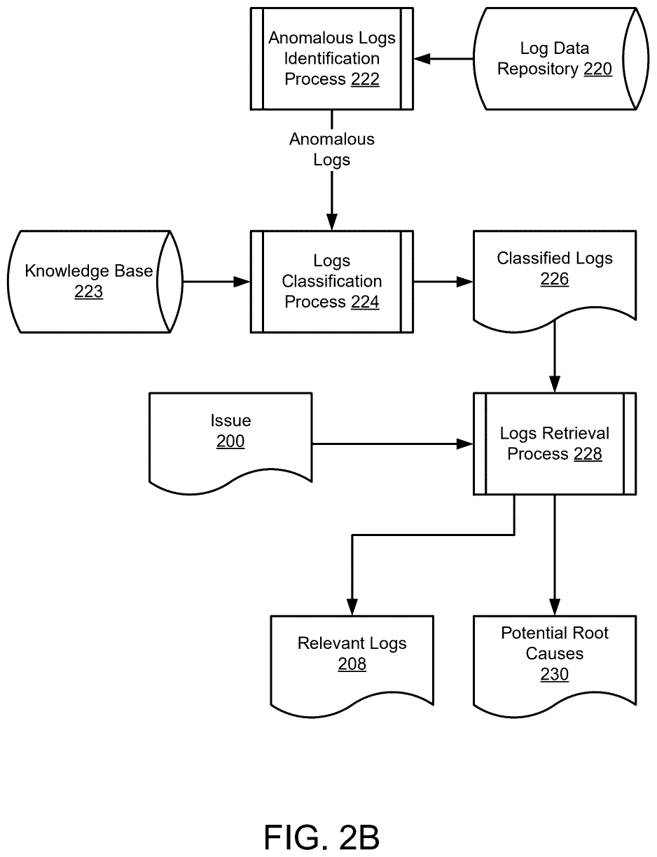

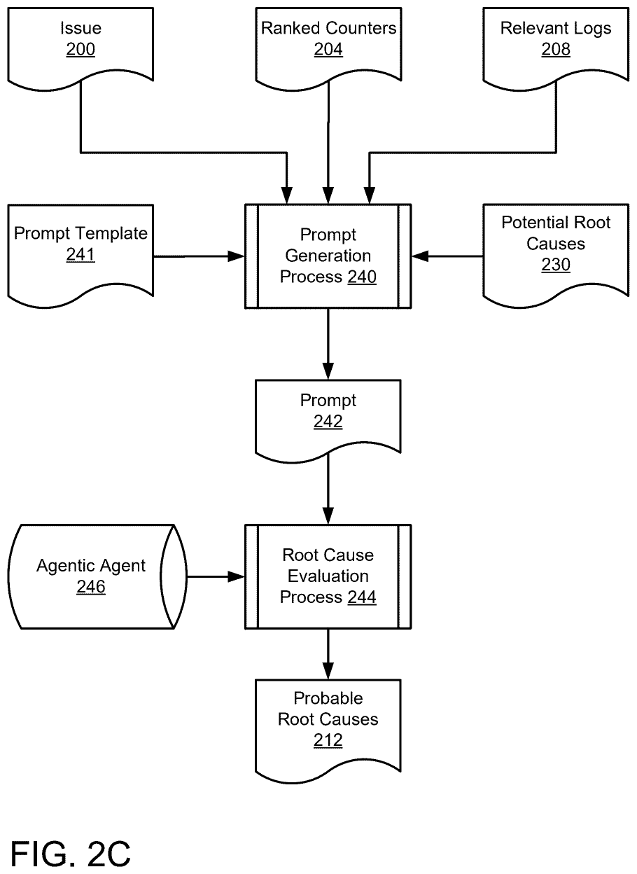

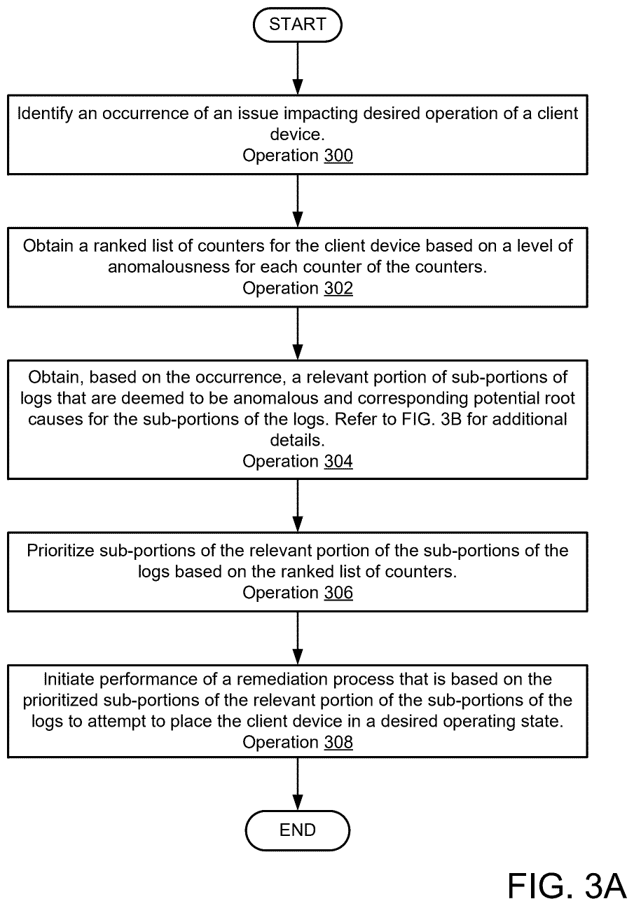

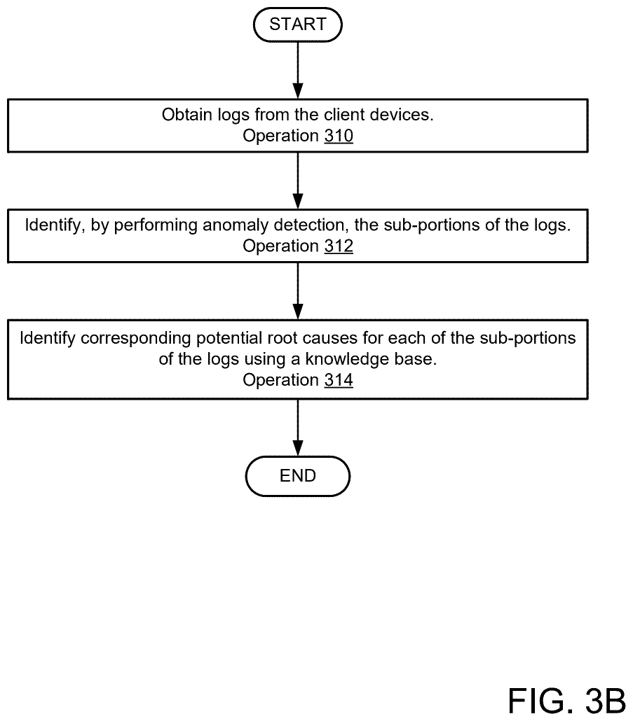

While providing their functionality, any of client devices 100, and management system 102 may provide all or a portion of the methods shown in FIGS. 2A-3B.

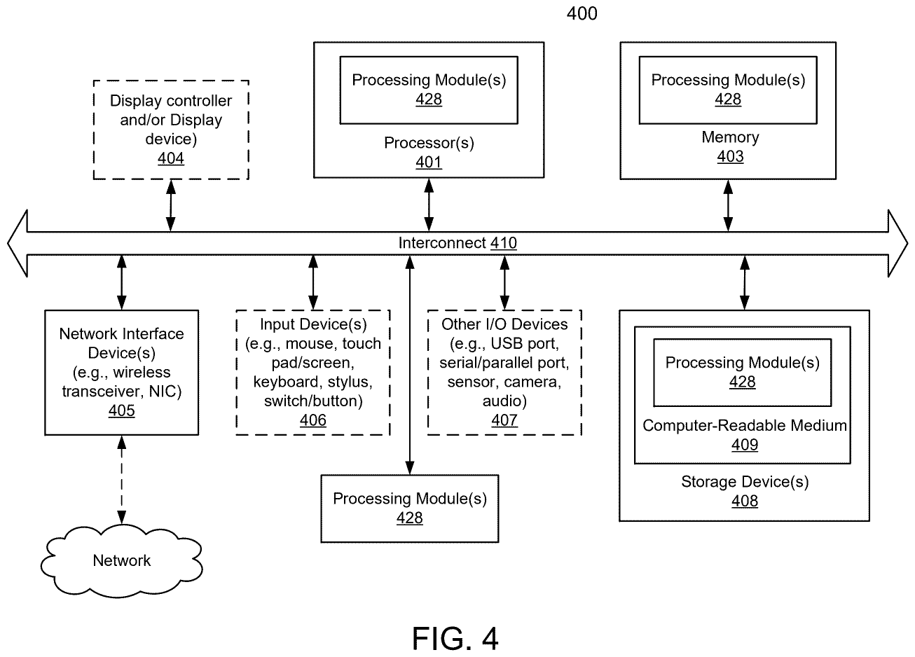

Communication system 104 may allow any of client devices 100, and management system 102 to communicate with one another (and/or with other devices not illustrated in FIG. 1). To provide its functionality, communication system 104 may be implemented with one or more wired and/or wireless networks. Any of these networks may be a radio access network (e.g., a cellular core network), a private network (e.g., the “Network” shown in FIG. 4), a public network, and/or may include the Internet. For example, client devices 100 may be operably connected to management system 102 via the Internet. Client devices 100, management system 102, and/or communication system 104 may be adapted to perform one or more protocols for communicating via communication system 104.

Any of (and/or components thereof) client devices 100, and management system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Thus, as shown in FIG. 1, a system in accordance with an embodiment may manage operation of client devices by obtaining a ranked list of probable root causes in response to an occurrence of an issue impacting operation of at least one client device. The ranked list of probable root causes may be obtained based on a filtered portion of logs generated by the client devices, a ranked list of counters for the client devices, and/or any other information. By doing so, a quality and/or timeliness of a performance of a remediation process may be improved to address the issue to place the client device in a desired operating state.

While illustrated in FIG. 1 with a limited number of specific components, a system may include additional, fewer, and/or different components without departing from embodiments disclosed herein.

To further clarify embodiments disclosed herein, data flow diagrams in accordance with an embodiment are shown in FIGS. 2A-2C. The data flow diagrams may illustrate how data is obtained and used within the system of FIG. 1. In these diagrams, flows of data and processing of data are illustrated using different sets of shapes. A first set of shapes (e.g., 200, 204, etc.) is used to represent data structures, a second set of shapes (e.g., 202, 206, etc.) is used to represent processes performed using and/or that generate data, and a third set of shapes (e.g., 214, 220, etc.) is used to represent large scale data structures such as databases.

Turning to FIG. 2A, a first data flow diagram in accordance with an embodiment is shown. The first data flow diagram may illustrate data used in and data processing performed in attempting to remediate an issue impacting operation of a client device.

Issue 200 may include any number and/or type of information regarding an occurrence of an issue impacting operation of a client device (e.g., 100A). Issue 200 may include, for example, an incident report submitted by a user, an automated alert provided to a management system (e.g., 102), a support ticket submitted by an entity tasked with managing operation of client devices (e.g., a support engineer), and/or any other information indicating the occurrence of the issue. Issue 200 may further include, for example, information regarding an affected component of a client device (e.g., an application, a hardware component, a version, etc.), description information (e.g., error message, issue description, etc.), frequency of the occurrence, severity of the issue (e.g., level of impact), and/or any other information.

To attempt to remediate the issue, anomaly scoring process 202 may be performed. During anomaly scoring process 202, a list of counters for the client device may be obtained, and the list of counters may be ranked based on levels of anomalousness for each counter. The list of counters may be obtained from counter repository 201. Counter repository 201 may include any number and/or type of information regarding execution of a codebase for the client device. For example, a counter may include a software checkpoint implemented in a corresponding portion of the codebase to count a number of instances when the portion of the codebase (e.g., a code segment) is executed while performing its functionality. Furthermore, counter repository 201 may include information regarding a historical frequency distribution of all counters for the codebase and/or the client device based on historical information (e.g., a normalized frequency distribution of counters based on historical root cause analysis information).

Accordingly, a level of anomalousness of each counter may be identified with respect to the historical frequency distribution. The level of anomalousness may be identified, for example, by evaluating deviation from the historical frequency distribution with respect to characteristics of issue 200. For example, consider a scenario where a counter for a given code segment is at the 25^{th} percentile during nominal (e.g., desired) operation as indicated by the historical frequency distribution. If the counter is identified to be at the 75^{th} percentile as a result of issue 200 (e.g., the given code segment is executed at a higher frequency due to an undesired looping of the given code segment), the counter may be identified to have a higher level of anomalousness compared to other counters. As such, the counter may be ranked higher in the ranked list of counters to indicate a higher likelihood that the corresponding portion of the codebase may be operating in an undesired manner.

By evaluating the levels of anomalousness for the counters, ranked counters 204 may be obtained for use in prioritizing investigative efforts towards the portions of the codebase that may have the higher likelihood of undesired operation. Ranked counters 204 may include, for example, the ranked list of counters, information regarding the portion of the codebase (e.g., lines of code, modules, etc.) corresponding to a counter, information regarding the level of anomalousness of the counter (e.g., a result of a function with learnable parameters based on the historical frequency distribution), and/or any other information.

To obtain a relevant portion of logs for issue 200, log identification process 206 may be performed. During log identification process 206, sub-portions of logs generated by the client devices may be identified to be anomalous, potential root causes may be associated with the sub-portions, and a relevant portion of the sub-portions of the logs may be obtained based on issue 200. To improve a likelihood that the relevant portion of the logs may be obtained for use in addressing issue 200 in a timely and/or precise manner, the sub-portions of all the logs generated by the client device may be identified prior to the occurrence of issue 200. For example, the sub-portions of the logs may be identified using anomaly detection and stored in storage (e.g., a cache) for subsequent retrieval in response to the occurrence of issue 200.

Furthermore, each of the sub-portions of the logs may be classified (e.g., using a trained inference model) to assign predefined potential root causes to each of the sub-portions of the logs that were deemed to be anomalous. As such, the relevant portion of logs (e.g., relevant logs 208) and corresponding potential root causes may be obtained based on issue 200 for use in diagnosing and/or remediating issue 200. Relevant logs 208 may include any number and/or type of information regarding anomalous log messages (e.g., historical log messages related to historical issues impacting operation of client devices) generated by at least a portion of the client devices. Refer to FIG. 2B for additional details regarding obtaining the relevant portion of logs and corresponding potential root causes based on the issue.

To identify probable root causes for the issue, root cause inferencing process 210 may be performed. During root cause inferencing process 210, portions of relevant logs 208 may be prioritized based on ranked counters 204, and a ranked list of probable root causes may be identified based on the prioritized portions of the relevant logs. For example, log messages that mention higher ranked counters of ranked counters 204 may be more relevant with respect to diagnosing a root cause for issue 200 compared to other log messages that mention lower ranked counters of ranked counters 204. As such, sub-portions (e.g., certain log messages) of the relevant portion of the sub-portions of the logs may be prioritized to improve an ability of an entity tasked with identifying the probable root causes for issue 200. The entity may include, for example, at least one agentic agent (e.g., an agentic artificial intelligence model) adapted to obtain the probable root causes 212 based on a prompt. The prompt may be generated based on the prioritized log messages, information regarding issue 200, and/or any other information. By doing so, probable root causes 212 may be obtained for use in resolving issue 200 when each probable root cause of probable root causes 212 is addressed. Refer to FIG. 2C for additional details regarding identifying the probable root causes.

To attempt to remediate the issue and place the client device in a desired operating state, management process 214 may be performed. During management process 214, probable root causes 212 may be addressed to resolve issue 200. For example, to address the probable root causes, at least one remediation process may be identified based on a probable root cause of probable root causes 212 (e.g., via searching a repository of remediation processes), the at least one remediation process may be performed to address the probable root cause, a result of the performance of the remediation process may be evaluated to determine whether the issue was resolved, and/or any other actions may be performed. The remediation process may include for example modifying operation of at least a portion of hardware and/or software components of the client device.

Thus, using the data flow shown in FIG. 2A, an issue impacting operation of a client device may be resolved by identifying and addressing probable root causes for the issue. The probable root causes may be identified in a more timely and/or precise manner by using counters and relevant logs for the client device. By doing so, a quality of computer-implemented services provided by a system including the client devices may be improved.

Turning to FIG. 2B, a second data flow diagram in accordance with an embodiment is shown. The second data flow diagram may illustrate data used in and data processing performed in obtaining a relevant portion of logs and corresponding potential root causes for a client device based on an occurrence of an issue.

To obtain the relevant portion of logs, anomalous logs identification process 222 may be performed. During anomalous logs identification process 222, a sub-portion of logs generated by the client devices may be identified to be anomalous. For example, to identify the sub-portion of the logs, at least a portion of the logs generated by the client devices may be obtained from log data repository 220, an anomaly detection process may be performed, and/or any other processes may be performed. Log data repository 220 may include any number and/or type of information regarding operation of the client devices (e.g., 100). For example, a log of log data repository 220 may include an identifier for the log, a message (e.g., describing an event, result, action, etc.), a timestamp, and/or any other information. Log data repository 220 may include, for example, logs generated by the client devices and may be aggregated and/or stored by a management system (e.g., 102).

The anomaly detection may include a multi-level anomaly detection adapted to classify the sub-portions of the logs at an individual device level and/or a system level. For example, a portion of log messages independently generated by a client device may be identified to be anomalous when compared to a second portion of the log messages with respect to the client device. Additionally, deviations from correlated log events based on events across a plurality of client devices may also be identified to be anomalous. The anomaly detection process may be performed, for example, using clustering algorithms, a trained machine learning model, statistical models, and/or any other method.

By identifying the sub-portion of the logs deemed to be anomalous, a sub-portion of the logs relevant to an issue may be more likely to be retrieved in a timely manner in response to the occurrence of the issue (e.g., by reducing a search space of logs to remove logs related to nominal behavior that may therefore be less relevant to the issue). Once identified, the sub-portions of the logs may be classified to associate potential root causes to each of the sub-portions of the logs.

To associate the potential root causes with the sub-portions of the logs, logs classification process 224 may be performed. During logs classification process 224, each of the sub-portions of the logs may be assigned a predefined root cause. For example, to assign a corresponding root cause to a sub-portion of the logs, information from knowledge base 223 may be used to map a root cause category to at least one log message. Knowledge base 223 may include, for example, historical root cause analysis (RCA) documentation, issues (e.g., support tickets), root cause results, remediation process results, corresponding log messages deemed to be relevant to an issue, and/or any other information. Furthermore, the information from knowledge base 223 may be reviewed by a subject matter expert to annotate training data that may be used to train an inference model usable to assign predefined root causes to the sub-portions of the logs. As a result of performing logs classification process 224, classified logs 226 may be obtained.

Classified logs 226 may include, for example, the sub-portions of the logs deemed to be anomalous along with the corresponding potential root causes (e.g., assigned using the trained inference model based on knowledge base 223). A corresponding potential root cause may be implemented, for example, as a data value of a data structure including a sub-portion of the logs, a separate data table with root causes related to the sub-portion of the logs via keys, buckets of the sub-portions of the logs organized based on the potential root cause, and/or any other method. Classified logs 226 may be obtained in response to the occurrence of the event and/or prior to the occurrence of the event (e.g., stored in storage for subsequent retrieval in response to the occurrence of the event).

To obtain a portion of the sub-portions of the logs relevant to issue 200, logs retrieval process 228 may be performed. During logs retrieval process 228, the sub-portions of the logs and corresponding potential root causes may be filtered. To filter the sub-portions of the logs, the sub-portions of the logs (e.g., a storage for the sub-portions of the logs) may be queried using at least one characteristic of issue 200. For example, consider a scenario in which issue 200 indicates an undesired behavior related to a multiple drive failure for a storage device. An identifier for the storage device, description of an error message, and/or any other information related to this issue may be used to query the sub-portions of the logs to obtain relevant logs 208 and potential root causes 230. Potential root causes 230 may, as previously discussed, be a labeled data value for a corresponding sub-portion of the logs, a separate list with keys mapping a root cause to a corresponding sub-portion of the logs, and/or any other data structure.

Thus, using the data flow shown in FIG. 2B, a sub-portion of logs generated by client devices may be identified to be anomalous and corresponding root causes may be associated with each sub-portion of the logs using a knowledge base. By doing so, a relevant portion of the sub-portion of the logs may be retrieved in response to an occurrence of an issue and used as contextual information to investigate and/or attempt to remediate the issue.

Turning to FIG. 2C, a third data flow diagram in accordance with an embodiment is shown. The third data flow diagram may illustrate data used in and data processing performed in obtaining a ranked list of probable root causes for the issue.

To obtain the ranked list of probable root causes, prompt generation process 240 may be performed. During prompt generation process 240, sub-portions of the relevant portion of the sub-portions of the logs may be prioritized, and at least one prompt may be generated based on the prioritized sub-portions. For example, as previously discussed in FIG. 2A, log messages of relevant logs 208 that mention higher ranked counters of ranked counters 204 may be more relevant with respect to diagnosing a root cause for issue 200 compared to other log messages that mention lower ranked counters of ranked counters 204. As such, sub-portions (e.g., certain log messages) of the relevant portion of the sub-portions of the logs may be prioritized to improve an ability of an entity tasked with identifying the probable root causes for issue 200.

To generate the at least one prompt, the prioritized log messages, issue 200, and/or any other information may be used with prompt template 241. Prompt template 241 may include at least one predefined prompt configured to provide instructions and/or a structure to obtain a desired response from a trained inference model (e.g., agentic agent 246). By doing so, prompt 242 may generated that may, for example, provide instructions for agentic agent 246 to generate a list of probable root causes using the prioritized log messages, information indicated by issue 200, potential root causes 230, and/or any other information as context information.

To obtain a final ranking of probable root causes for use in identify a remediation process, root cause evaluation process 244 may be performed. During root cause evaluation process 244, at least one agentic agent may perform a set of actions to generate the ranked list of probable root causes. Agentic agent 246 may include, for example, a framework of artificial intelligence models adapted to autonomously act while operating under predefined constraints. For example, agentic agent 246 may be trained to follow a predefined workflow (e.g., implemented via one or more modules) to generate the ranked list of probable root causes, attempt to remediate an issue based on the probable root causes, and/or perform any other actions. Furthermore, agentic agent 246 may be updated based on feedback (e.g., verification of probable root causes generated) by an entity tasked with managing agentic agent 246 (e.g., a developer), results of actions performed, and/or via any other processes.

To perform the set of actions to generate the ranked list of probable root causes, agentic agent 246 may, for example, (i) identify subtasks to perform to validate each of the prioritized log messages with respect to the corresponding potential root cause, (ii) perform the identified subtasks, (iii) evaluate results of the performance of the subtasks, (iv) generate the ranked list of probable root causes based on the evaluation, and/or perform any other actions.

For example, consider a scenario in which a prioritized log message for a client device is associated with a potential root cause being a damaged disk slot. Agentic agent 246 may identify a set of subtasks to be performed to validate the potential root cause. The set of subtasks may include, for example, retrieving relevant disk details from the logs, identifying at least one command to obtain a list of disks connected to the client device, searching the disk details from the results of the previous subtasks, and/or performing any other actions. Once identified, agentic agent 246 may execute each of the subtasks by interacting with an interface of the client device (e.g., via predefined commands). The results of the execution of the subtasks may be evaluated to determine whether each result meets criteria to conclude that a log message is correlated with a potential root cause. The conclusions (e.g., level of correlation) may be used to rank the potential root causes to obtain the ranked list of probable root causes (e.g., probable root causes 212). At least a portion of probable root causes 212 (e.g., that meet second criteria, confidence level, etc.) may be used to provided to a user (e.g., of management system 102) and/or used by agentic agent 246 to iteratively address each of the at least a portion of probable root causes 212 until issue 200 is resolved or the list of probable root causes is exhausted.

Thus, using the data flow shown in FIG. 2C, a ranked list of probable root causes may be obtained using an agentic agent and based on relevant logs, corresponding potential root causes, information regarding an occurrence of an issue, and/or any other information. By doing so, the issue impacting operation of a client device may be resolved by addressing at least a portion of the probable root causes to place the client device in a desired operating state.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage operation of client devices. FIGS. 3A-3B illustrate methods that may be performed by the components of the system of FIG. 1. In the diagrams discussed below and shown in FIGS. 3A-3B, any of the operations may be repeated, performed in different orders, and/or performed in parallel with or in a partially overlapping in time manner with other operations.

Turning to FIG. 3A, a first flow diagram illustrating a method of managing operation of client devices in accordance with an embodiment is shown. The method may be performed, for example, by any of the components of the system of FIG. 1, and/or other components not shown therein.

At operation 300, an occurrence of an issue impacting desired operation of a client device may be identified. The occurrence may be identified by: (i) receiving a user report (e.g., support tickets, feedback forms, etc.), (ii) utilizing automated monitoring to receive alerts relevant to the issue, (iii) receiving a request to service at least one component of the client device, and/or via any other processes.

At operation 302, a ranked list of counters for the client device may be obtained based on a level of anomalousness for each counter of the counters. The ranked list may be obtained by: (i) obtaining a set of counters implemented to count a frequency which a portion of a codebase executes during the occurrence of the issue, (ii) obtaining a historical frequency distribution for counters for the client device, (iii) calculating a level of deviation (e.g., an anomaly score) of the set of counters during the occurrence of the issue with respect to the historical frequency distribution, (iv) ranking the counters based on the level of deviation, and/or via any other processes.

At operation 304, a relevant portion of sub-portions of logs that are deemed to be anomalous and corresponding root causes may be obtained based on the occurrence of the issue. The relevant portion of sub-portions of logs and corresponding root causes may be obtained by: (i) identifying the sub-portions of the logs (e.g., historical logs) that may indicate anomalous behavior, (ii) storing the sub-portions of the logs in a cache for subsequent retrieval in response to the occurrence of the issue, (iii) classifying the sub-portions of the logs to associate a potential root cause with the anomalous behavior indicated by the logs, (iv) filtering the sub-portions of the logs based on the issue to obtain the relevant portion, (v) searching the cache using the issue as part of a query, and/or performing any other actions. Refer to FIG. 3B for additional information regarding identifying the sub-portions of the logs and assigning corresponding potential root causes.

At operation 306, sub-portions of the relevant portion of the sub-portions of the logs may be prioritized based on the ranked list of counters. The sub-portions of the relevant portion may be prioritized by: (i) identifying line numbers for the codebase mentioned in a log messages, (ii) reranking log messages that mention line numbers corresponding to higher ranked counters (e.g., more anomalous, relevant to the issue, etc.), and/or via any other processes.

At operation 308, performance of a remediation process may be initiated to attempt to place the client device in a desired operating state. The performance of the remediation process may be initiated by: (i) generating a prompt using a prompt template based on the prioritized log messages, (ii) utilizing an agentic agent to validate the potential root causes and generate a ranked list of probable root causes, (iii) searching a repository of remediation processes based on the probable root causes, (iv) modifying a portion of the codebase to resolve the issue, and/or performing any other processes.

The method may end following operation 308.

Using the method shown in FIG. 3A, operation of a data processing system may be managed by obtaining a ranked list of probable root causes in response to an occurrence of an issue impacting operation of at least one client device. The ranked list of probable root causes may be obtained based on a filtered portion of logs generated by the client devices, a ranked list of counters for the client devices, and/or any other information. By doing so, a quality and/or timeliness of a performance of a remediation process may be improved to address the issue to place the client device in a desired operating state.

Turning to FIG. 3B, a second flow diagram illustrating a method of managing operation of a identifying anomalous sub-portions of logs and corresponding potential root causes in accordance with an embodiment is shown. The method may be performed, for example, by any of the components of the system of FIG. 1, and/or other components not shown therein.

At operation 310, logs may be obtained from the client devices. The logs may be obtained from the client devices by: (i) receiving at least a portion of logs generated by the client devices based on a subscription to receive logs, (ii) utilizing application programming interfaces to programmatically retrieve the logs for centralized collection, (iii) aggregating the logs for processing and/or subsequent storage, and/or via any other processes.

At operation 312, the sub-portions of the logs may be identified. The sub-portion of the logs may be identified by: (i) configuring an anomaly detection mechanism to evaluate a level of anomalousness of each sub-portion of logs, (ii) identifying anomalous sections of logs generated by each client device, (iii) identifying deviations from expected correlations between various events across all client devices, and/or via any other processes.

At operation 314. corresponding potential root causes for each of the sub-portions of the logs may be identified using a knowledge base. The corresponding potential root causes for each of the sub-portions of the logs may be identified by: (i) training a classification model using historical root cause analysis documents, (ii) evaluating, by a subject matter expert, final root causes and corresponding log messages of the historical information to obtain labeled training data, (iii) classifying the sub-portions of the logs using the trained classification model, (iv) supplementing the sub-portions of the logs with the corresponding potential root causes from the knowledge base, (v) storing the sub-portions of the logs in buckets segmented based on the corresponding potential root causes, and/or via any other processes.

The method may end following operation 314.

Using the method shown in FIG. 3B, a sub-portion of logs obtained from the client devices may be identified to be anomalous (e.g., thereby more relevant to issues) and corresponding potential root causes may be associated with the sub-portion of logs. The sub-portion of logs and corresponding potential root causes may be stored for subsequent retrieval in response to the occurrence of the issue. By doing so, a timeliness of obtaining a relevant portion of logs for use in identifying probable root causes for the issue may be improved.

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as Vx Works.

System 400 may further include IO (Input/Output) devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random-access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

1. A method of managing operation of client devices, the method comprising:
identifying an occurrence of an issue impacting desired operation of a client device of the client devices;
in response to the occurrence of the issue:
obtaining a ranked list of counters for the client device based on a level of anomalousness for each counter of the counters, a counter of the counters indicating a frequency that a corresponding portion of a codebase of the client device executes while the issue impacts the desired operation,
wherein the ranked list of counters is ranked based on the level of anomalousness of each of the counters relative to a historical frequency distribution for the counters;
obtaining, based on the occurrence, a relevant portion of sub-portions of logs that are deemed to be anomalous and corresponding potential root causes for the sub-portions of the logs;
prioritizing sub-portions of the relevant portion of the sub-portions of the logs based on the ranked list of the counters; and
initiating performance of a remediation process that is based on the prioritized sub-portions of the relevant portion of the sub-portions of the logs to attempt to place the client device in a desired operating state to facilitate continued provisioning of desired computer implemented services.

2. The method of claim 1, further comprising:
obtaining the logs from the client devices;
identifying, by performing anomaly detection, the sub-portions of the logs; and
identifying corresponding potential root causes for each of the sub-portions of the logs using a knowledge base.

3. The method of claim 2, wherein the anomaly detection is a multi-level anomaly detection process, the multi-level anomaly detection process classifying the sub-portions of the logs at an individual device level and at a system level to identify the sub-portions of the logs.

4. The method of claim 2, wherein obtaining the relevant portion of the sub-portions of the logs comprises:
filtering the sub-portions of the logs and the corresponding potential root causes based on the issue to obtain the relevant portion.

5. (canceled)

6. The method of claim 1, wherein prioritizing the sub-portions of the relevant portion comprises:
rank ordering the sub-portions of the relevant portion of the sub-portions of the logs based on the ranked list of the counters.

7. The method of claim 6, wherein initiating the performance comprises:
generating, based on the rank ordering and the issue, at least one prompt; and
initiating the performance of the remediation process by an agentic agent using the at least one prompt.

8. The method of claim 7, wherein the agentic agent is adapted to attempt to obtain a ranked list of probable root causes of the issue based on the at least one prompt.

9. The method of claim 8, wherein the agentic agent is further adapted to attempt to remediate the issue by iteratively addressing each of the probable root causes until the issue is resolved or the ranked list is exhausted.

10. A non-transitory machine-readable medium having instructions stored therein, which when executed by a processor, cause the processor to perform operations for managing operation of client devices, the operations comprising:
identifying an occurrence of an issue impacting desired operation of a client device of the client devices;
in response to the occurrence of the issue:
obtaining a ranked list of counters for the client device based on a level of anomalousness for each counter of the counters, a counter of the counters indicating a frequency that a corresponding portion of a codebase of the client device executes while the issue impacts the desired operation,
wherein the ranked list of counters is ranked based on the level of anomalousness of each of the counters relative to a historical frequency distribution for the counters;
obtaining, based on the occurrence, a relevant portion of sub-portions of logs that are deemed to be anomalous and corresponding potential root causes for the sub-portions of the logs;
prioritizing sub-portions of the relevant portion of the sub-portions of the logs based on the ranked list of the counters; and
initiating performance of a remediation process that is based on the prioritized sub-portions of the relevant portion of the sub-portions of the logs to attempt to place the client device in a desired operating state to facilitate continued provisioning of desired computer implemented services.

11. The non-transitory machine-readable medium of claim 10, wherein the operations further comprise:
obtaining the logs from the client devices;
identifying, by performing anomaly detection, the sub-portions of the logs; and
identifying corresponding potential root causes for each of the sub-portions of the logs using a knowledge base.

12. The non-transitory machine-readable medium of claim 11, wherein the anomaly detection is a multi-level anomaly detection process, the multi-level anomaly detection process classifying the sub-portions of the logs at an individual device level and at a system level to identify the sub-portions of the logs.

13. The non-transitory machine-readable medium of claim 11, wherein obtaining the relevant portion of the sub-portions of the logs comprises:
filtering the sub-portions of the logs and the corresponding potential root causes based on the issue to obtain the relevant portion.

14. (canceled)

15. The non-transitory machine-readable medium of claim 10, wherein prioritizing the sub-portions of the relevant portion comprises:
rank ordering the sub-portions of the relevant portion of the sub-portions of the logs based on the ranked list of the counters.

16. A data processing system, comprising:
a processor; and
a memory coupled to the processor to store instructions, which when executed by the processor, cause the processor to perform operations for managing operation of client devices, the operations comprising:
identifying an occurrence of an issue impacting desired operation of a client device of the client devices;
in response to the occurrence of the issue:
obtaining a ranked list of counters for the client device based on a level of anomalousness for each counter of the counters, a counter of the counters indicating a frequency that a corresponding portion of a codebase of the client device executes while the issue impacts the desired operation,
wherein the ranked list of counters is ranked based on the level of anomalousness of each of the counters relative to a historical frequency distribution for the counters;
obtaining, based on the occurrence, a relevant portion of sub-portions of logs that are deemed to be anomalous and corresponding potential root causes for the sub-portions of the logs;
prioritizing sub-portions of the relevant portion of the sub-portions of the logs based on the ranked list of the counters; and
initiating performance of a remediation process that is based on the prioritized sub-portions of the relevant portion of the sub-portions of the logs to attempt to place the client device in a desired operating state to facilitate continued provisioning of desired computer implemented services.

17. The data processing system of claim 16, wherein the operations further comprise:
obtaining the logs from the client devices;
identifying, by performing anomaly detection, the sub-portions of the logs; and
identifying corresponding potential root causes for each of the sub-portions of the logs using a knowledge base.

18. The data processing system of claim 17, wherein the anomaly detection is a multi-level anomaly detection process, the multi-level anomaly detection process classifying the sub-portions of the logs at an individual device level and at a system level to identify the sub-portions of the logs.

19. The data processing system of claim 17, wherein obtaining the relevant portion of the sub-portions of the logs comprises:
filtering the sub-portions of the logs and the corresponding potential root causes based on the issue to obtain the relevant portion.

20. (canceled)

21. The data processing system of claim 16, wherein prioritizing the sub-portions of the relevant portion comprises:
rank ordering the sub-portions of the relevant portion of the sub-portions of the logs based on the ranked list of the counters.

22. The data processing system of claim 21, wherein initiating the performance comprises:
generating, based on the rank ordering and the issue, at least one prompt; and
initiating the performance of the remediation process by an agentic agent using the at least one prompt.

23. The data processing system of claim 22, wherein the agentic agent is adapted to attempt to obtain a ranked list of probable root causes of the issue based on the at least one prompt.
